(19) United States
(12) Patent Application Publication
(10) Pub. No.: US 2026/0148643 A1
(43) Pub. Date: May 28, 2026

(54) FLIGHT PATH PROVISION DEVICE, METHOD AND COMPUTER PROGRAM

(71) Applicant: SK TELECOM CO., LTD., Seoul (KR)

(72) Inventors: Wonju CHOI, Seoul (KR); Byungryong KANG, Seoul (KR); Youngsang ROH, Seoul (R)

(21) Appl. No.: 19/446,354

(22) Filed: Jan. 12, 2026

Related U.S. Application Data
(63) Continuation of application No. PCT/KR2024/016083, filed on Oct. 22, 2024.

(30) Foreign Application Priority Data
Oct. 24, 2024 (KR) 10-2023-0143336

(51) Int. Cl. G08G 5/34; G08G 5/80; G08G 5/90

(52) U.S. Cl. CPC G08G 5/34; G08G 5/80; G08G 5/90

(57) ABSTRACT

In accordance with an embodiment, there is provided a method for providing flight path using a flight path providing apparatus, the method comprising: calculating at least one candidate departure time and at least one candidate arrival time based on a flight service request including a desired departure time, a departure location, and an arrival location; generating at least one candidate flight path based on the at least one candidate departure time and the at least one candidate arrival time; generating at least one candidate flight information including a flight path, a departure time, and an arrival time corresponding to the at least one candidate flight path; and determining recommended flight information from among the at least one candidate flight information based on at least one of the flight path, the departure time, and the arrival time included in the at least one candidate flight information.

### CROSS-REFERENCE TO RELATED APPLICATION

This application is a continuation of PCT International Patent Application No. PCT/KR2024/016083 filed on Oct. 22, 2024, which claims the benefit of priority to Korean Patent Application No. 10-2023-0143336, filed on Oct. 24, 2023 in the Korean Intellectual Property Office. The aforementioned applications are hereby incorporated by reference in their entireties.

### TECHNICAL FIELD

An embodiment relates to a technology for providing a flight path for an aircraft, such as a UAM, to fly.

### BACKGROUND

In a conventional aviation system, when an unscheduled flight plan occurs, a flight operations manager checks flight plans submitted to a traffic control system to confirm and submit a flight path that does not overlap with the flight plans of other aircraft. As a result, it is inevitable that the review of these flight plans is time-consuming.

However, for aircraft providing flight services within urban areas, such as UAM, situations where flight path planning is requested in real-time according to non-scheduled requests from customers occur frequently, so flight operations managers need to establish flight plans quickly.

### SUMMARY

An object of an embodiment is to provide a technology for generating a flight path for providing a flight service based on a customer's request.

Furthermore, an object of an embodiment is to provide a technology for generating an optimal flight path in response to a customer's request.

Furthermore, an object of an embodiment is to provide a technology for generating a flight path that may avoid a collision with another aircraft.

Furthermore, an object of an embodiment is to provide a technology for generating a flight path of minimum cost in response to a customer's request.

According to an aspect of an embodiment, a method for providing flight path comprises: calculating at least one candidate departure time and at least one candidate arrival time based on a flight service request including a desired departure time, a departure location, and an arrival location; generating at least one candidate flight path based on the at least one candidate departure time and the at least one candidate arrival time; generating at least one candidate flight information including a flight path, a departure time, and an arrival time corresponding to the at least one candidate flight path that satisfies at least one among the at least one candidate departure time and the at least one candidate arrival time; and determining recommended flight information from among the at least one candidate flight information, based on at least one of the flight path, the departure time, and the arrival time included in the at least one candidate flight information.

In an embodiment, the calculating at least one candidate departure time and at least one candidate arrival time may include: determining, as at least one candidate departure time, at least one time that is within a preset time based on the desired departure time among the times available for the departure location; calculating a minimum flight time between the departure location and the arrival location; and calculating at least one candidate arrival time based on the at least one candidate departure time and the minimum flight time.

In an embodiment, the calculating a minimum flight time between the departure location and the arrival location may include: calculating the flight time along a minimum flight path between the departure location and the arrival location as the minimum flight time.

In an embodiment, the generating the minimum flight path between the departure location and the arrival location may generate the minimum flight path based on a preset flight duration between a plurality of waypoints located between the departure location and the arrival location.

In an embodiment, the calculating at least one candidate arrival time based on the at least one candidate departure time and the minimum flight time may determine, as at least one candidate arrival time, at least one time after the minimum flight time has elapsed from the at least one candidate departure time, among the times available for the arrival location.

In an embodiment, the generating at least one candidate flight information may include: determining whether there is a collision possibility with another aircraft when flying along the at least one candidate flight path; and when it is determined that the collision possibility exists, calculating a departure time and an arrival time corresponding to the at least one candidate flight path by changing at least one of the candidate departure time and a preset flight duration between waypoints constituting the at least one candidate flight path.

In an embodiment, the at least one candidate flight information may further include a cost corresponding to the at least one candidate flight path, and wherein, in determining recommended flight information from among the at least one candidate flight information, the recommended flight information may be determined by further including the cost.

In an embodiment, the flight path providing method may further include: receiving the flight service request from a user terminal; and transmitting the recommended flight information to the user terminal.

According to another aspect of an embodiment, a flight path providing apparatus comprises: a memory including instructions; and a processor executing the instructions wherein instructions, when executed by the processor, causes the processor to: calculate at least one candidate departure time and at least one candidate arrival time based on a flight service request including a desired departure time, a departure location, and an arrival location, generate at least one candidate flight path based on the at least one candidate departure time and the at least one candidate arrival time, generate at least one candidate flight information including a flight path, a departure time, and an arrival time corresponding to the at least one candidate flight path that satisfies at least one among the at least one candidate departure time and the at least one candidate arrival time, and determine recommended flight information from among the at least one candidate flight information, based on at least one of the flight path, the departure time, and the arrival time included in the at least one candidate flight information.

The above aspects of an embodiment provide for generating a flight path for a flight service based on a customer's request.

Furthermore, the aspect of an embodiment provides for generating an optimal flight path in response to a customer's request.

Furthermore, the aspect of an embodiment provides for generating a flight path that may avoid a collision with another aircraft.

Furthermore, the aspect of an embodiment provides for generating a flight path of minimum cost in response to a customer's request.

### BRIEF DESCRIPTION OF THE DRAWINGS

FIG. 1 is a block diagram of a flight path providing apparatus according to the another aspect of the embodiment.

FIG. 2 is a flowchart of a flight path providing method according to the aspect of the embodiment.

FIGS. 3 to 7 are diagrams for explaining a recommended path providing method according to an embodiment.

FIG. 8 is a block diagram of a flight path providing apparatus according to another embodiment.

### DETAILED DESCRIPTION

The advantages and features of an embodiment and the methods of achieving them will become clear with reference to the embodiments described in detail below with the accompanying drawings. However, an embodiment is not limited to the embodiments disclosed below but may be embodied in various forms. These embodiments are provided only to complete this disclosure and to fully inform a person of ordinary skill in the art to which an embodiment pertains of the scope of the invention, and the scope of protection of an embodiment should be interpreted by the claims.

In describing the embodiments, detailed descriptions of known functions or configurations will be omitted except when they are actually necessary for explaining the embodiments. And the terms used below are defined in consideration of their functions in the embodiments, and they may vary depending on the intention or custom of a user or operator.

Hereinafter, terms such as ‘ . . . unit’ and ‘ . . . device’ refer to a unit that processes at least one function or operation, and may be implemented as hardware, software, or a combination of hardware and software.

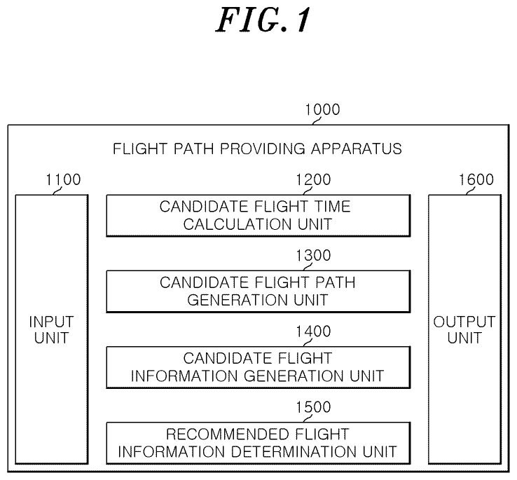

FIG. 1 is a block diagram of a flight path providing apparatus according to the another aspect of the embodiment of the present invention.

Referring to FIG. 1, a flight path providing apparatus 1000 according to the another aspect of the embodiment may include an input unit 1100, a candidate flight time calculation unit 1200, a candidate flight path generation unit 1300, a candidate flight information generation unit 1400, a recommended flight information determination unit 1500, and an output unit 1600.

The input unit 1100 may obtain any data used for providing a flight path by using wired/wireless communication means.

Furthermore, the input unit 1100 may receive a flight service request including a desired departure time, a departure location, an arrival location, passenger information, weights, and the like, from an external device (not shown).

In an embodiment, the departure location and the arrival location may refer to a place where an aircraft may take off and land, such as a vertiport.

In an embodiment, the external device may be a terminal of a customer who intends to use an aircraft such as a UAM (hereinafter, referred to as a user terminal).

Furthermore, the input unit 1100 may obtain information about a plurality of waypoints located between the departure location and the arrival location, the flight plan of another aircraft, and the like, from an external device (not shown) such as a control tower, by using wired/wireless communication means.

In an embodiment, information about a plurality of waypoints may include a preset flight duration between the plurality of waypoints, whether flight is prohibited, and the like.

In an embodiment, the flight plan of another aircraft may include information such as waypoints constituting a flight path, a time of passing through each waypoint, and the like.

Furthermore, the input unit 1100 may obtain a request to select specific flight information from the user terminal by using wired/wireless communication means.

The candidate flight time calculation unit 1200 may calculate a candidate departure time and a candidate arrival time based on a service request.

In an embodiment, the candidate flight time calculation unit 1200 may determine at least one time, which is within a preset time range (e.g., −10 minutes to +10 minutes) based on the desired departure time among the available times for the departure location, as at least one candidate departure time.

In an embodiment, the candidate flight time calculation unit 1200 may calculate a minimum flight time between the departure location and the arrival location. In an embodiment, the flight path providing apparatus 1000 may calculate the shortest flight path based on a preset flight duration between a plurality of waypoints located between the departure location and the arrival location. The candidate flight time calculation unit 1200 may determine the preset flight duration between the waypoints constituting the shortest flight path as the minimum flight time.

In an embodiment, the candidate flight time calculation unit 1200 may calculate the shortest flight path by excluding at least one waypoint where flight is prohibited or restricted from among the plurality of waypoints located between the departure location and the arrival location. Here, the at least one waypoint where flight is prohibited or restricted may refer to a waypoint included in an area where flight is prohibited by a NOTAM (Notice to Air-mission).

In an embodiment, a candidate flight time calculation unit 1200 may calculate the shortest flight path by applying a shortest path algorithm, such as Dijkstra's algorithm, to a plurality of waypoints located between the departure location and the arrival location.

In an embodiment, the candidate flight time calculation unit 1200 may calculate at least one candidate arrival time based on at least one candidate departure time and the minimum flight time. In an embodiment, the candidate flight time calculation unit 1200 may determine a time at which the arrival location may be used for landing, from among at least one time after the minimum flight time has elapsed from the at least one candidate departure time, as at least one candidate arrival time.

The candidate flight path generation unit 1300 may generate a candidate flight path based on the candidate departure time and the candidate arrival time.

In an embodiment, the candidate flight path generation unit 1300 may determine, as a candidate flight path, at least one flight path that satisfies at least one candidate departure time and at least one candidate arrival time from among the flight paths composed of at least one of a plurality of waypoints located between the departure location and the arrival location. In an embodiment, the candidate flight path generation unit 1300 may determine, as a candidate flight path, at least one flight path that departs at at least one candidate departure time and satisfies at least one candidate arrival time after the minimum flight time has elapsed.

The candidate flight information generation unit 1400 may generate at least one candidate flight information including a flight path, a departure time, an arrival time, a cost, etc., corresponding to at least one candidate flight path.

In an embodiment, the candidate flight information generation unit 1400 may change a candidate departure time corresponding to at least one candidate flight path, a preset flight duration between at least one waypoint constituting the at least one candidate flight path, etc., and generate at least one candidate flight information including the changed departure time, arrival time, etc. Accordingly, two or more sets of candidate flight information with different departure times and flight speeds between waypoints may be generated from a single candidate flight path.

In an embodiment, the candidate flight information generation unit 1400 may determine whether there is a possibility of collision with another aircraft at at least one waypoint when flying along at least one candidate path, based on the flight information of the other aircraft. The candidate flight information generation unit 1400 may change the candidate departure time, the flight duration between at least one waypoint constituting the at least one candidate path, etc., so that the time of passing through the at least one waypoint where there is a possibility of collision is different from the passage time of the other aircraft. The candidate flight information generation unit 1400 may generate candidate flight information including the changed departure time, flight duration, etc.

In an embodiment, the candidate flight information generation unit 1400 may apply a weight to at least one flight duration between waypoints constituting a candidate path, and change the flight duration between the waypoints based on the applied weight. In an embodiment, the candidate flight information generation unit 1400 may change the degree of change in the flight duration between waypoints with a higher weight to be relatively larger or smaller than the degree of change in the flight duration between waypoints with a lower weight.

In an embodiment, the candidate flight information generation unit 1400 may calculate a fare cost corresponding to at least one candidate flight path, a changed departure time, a flight duration, etc., thereby generating candidate flight information including the cost.

The recommended flight information determination unit 1500 may determine the recommended flight information to be provided to a customer or the like from among the candidate flight information based on departure time, arrival time, cost, and so on.

In an embodiment, the recommended flight information determination unit 1500 may determine the recommended flight information by placing a weight on the departure time. In an embodiment, if the flight service request includes a request to prioritize the departure time, the flight information including the earliest departure time among the candidate flight information may be determined as the recommended flight information.

In an embodiment, the recommended flight information determination unit 1500 may determine the recommended flight information by placing a weight on the arrival time. In an embodiment, if the flight service request includes a request to prioritize the arrival time, the flight information including the earliest arrival time among the candidate flight information may be determined as the recommended flight information.

In an embodiment, the recommended flight information determination unit 1500 may determine the recommended flight information by placing a weight on the cost. In an embodiment, if the flight service request includes a request to prioritize the cost, the flight information including the lowest cost among the candidate flight information may be determined as the recommended flight information.

The output unit 1600 may transmit data to an external device (not shown) using wired/wireless communication means.

In an embodiment, the output unit 1600 may transmit at least one recommended flight information to the user terminal. Thereafter, when a request to select a recommended flight path is received from the user terminal, the flight path providing apparatus 1000 may confirm the corresponding recommended flight path as the flight path to be provided to the customer.

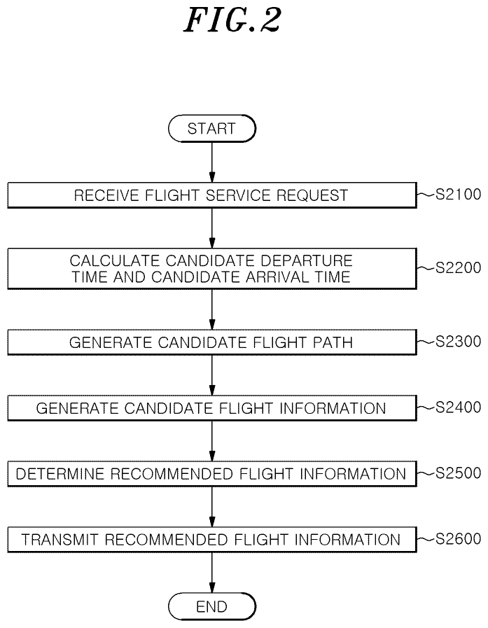

FIG. 2 is a flowchart of a flight path providing method according to the aspect of the embodiment of the present invention.

Hereinafter, the method will be described by way of example as being performed by the flight path providing apparatus 1000 shown in FIG. 1.

In step S2100, the flight path providing apparatus 1000 may receive a flight service request including a desired departure time, a departure location, an arrival location, passenger information, etc., from an external device (not shown).

In an embodiment, the departure location and the arrival location may refer to a place where an aircraft may take off and land, such as a vertiport.

In an embodiment, the external device may be a terminal of a customer who intends to use an aircraft such as a UAM (hereinafter, referred to as a user terminal).

In step S2200, the flight path providing apparatus 1000 may calculate a candidate departure time and a candidate arrival time based on the flight service request.

In an embodiment, the flight path providing apparatus 1000 may determine at least one time, which is within a preset time range (e.g., −10 minutes to +10 minutes) based on the desired departure time among the available times for the departure location, as at least one candidate departure time.

In an embodiment, the flight path providing apparatus 1000 may calculate a minimum flight time between the departure location and the arrival location. In an embodiment, the flight path providing apparatus 1000 may calculate the shortest flight path based on a preset flight duration between a plurality of waypoints located between the departure location and the arrival location. The flight path providing apparatus 1000 may determine the preset flight duration between the waypoints constituting the shortest flight path as the minimum flight time.

In an embodiment, the flight path providing apparatus 1000 may calculate the shortest flight path by excluding at least one waypoint where flight is prohibited or restricted from among the plurality of waypoints located between the departure location and the arrival location. Here, the at least one waypoint where flight is prohibited or restricted may refer to a waypoint included in an area where flight is prohibited by a NOTAM (Notice to Air-mission).

In an embodiment, the flight path providing apparatus 1000 may calculate the shortest flight path by applying a shortest path algorithm, such as Dijkstra's algorithm, to a plurality of waypoints located between the departure location and the arrival location.

In an embodiment, the flight path providing apparatus 1000 may calculate at least one candidate arrival time based on at least one candidate departure time and the minimum flight time. In an embodiment, the flight path providing apparatus 1000 may determine a time at which the arrival location may be used for landing, from among at least one time after the minimum flight time has elapsed from the at least one candidate departure time, as at least one candidate arrival time.

In step S2300, the flight path providing apparatus 1000 may generate a candidate flight path based on the candidate departure time and the candidate arrival time.

In an embodiment, the flight path providing apparatus 1000 may determine, as a candidate flight path, at least one flight path that satisfies at least one candidate departure time and at least one candidate arrival time from among the flight paths composed of at least one of a plurality of waypoints located between the departure location and the arrival location. In an embodiment, the flight path providing apparatus 1000 may determine, as a candidate flight path, at least one flight path that departs at at least one candidate departure time and satisfies at least one candidate arrival time after the minimum flight time has elapsed.

In step S2400, the flight path providing apparatus 1000 may generate at least one candidate flight information including a flight path, a departure time, an arrival time, a cost, etc., corresponding to at least one candidate flight path.

In an embodiment, the flight path providing apparatus 1000 may change a candidate departure time corresponding to at least one candidate flight path, a preset flight duration between at least one waypoint constituting the at least one candidate flight path, etc., and generate at least one candidate flight information including the changed departure time, arrival time, etc. Accordingly, two or more sets of candidate flight information with different departure times and flight speeds between waypoints may be generated from a single candidate flight path.

In an embodiment, the flight path providing apparatus 1000 may receive, from an external device such as a control tower, flight information of another aircraft flying through at least one waypoint constituting at least one candidate path within the candidate departure time and candidate arrival time. The flight path providing apparatus 1000 may determine whether there is a possibility of collision with another aircraft at at least one waypoint when flying along the at least one candidate path, based on the flight information of the other aircraft. The flight path providing apparatus 1000 may change the candidate departure time, the flight duration between at least one waypoint constituting the at least one candidate path, etc., so that the time of passing through the at least one waypoint where there is a possibility of collision is different from the passage time of the other aircraft. The flight path providing apparatus 1000 may generate candidate flight information including the changed departure time, flight duration, etc.

In an embodiment, the flight path providing apparatus 1000 may apply a weight to at least one flight duration between waypoints constituting a candidate path, and change the flight duration between the waypoints based on the applied weight. In an embodiment, the flight path providing apparatus 1000 may change the degree of change in the flight duration between waypoints with a higher weight to be relatively larger or smaller than the degree of change in the flight duration between waypoints with a lower weight.

In an embodiment, the flight path providing apparatus 1000 may calculate a fare cost corresponding to at least one candidate flight path, a changed departure time, a flight duration, etc., thereby generating candidate flight information including the cost.

In step S2500, the flight path providing apparatus 1000 may determine the recommended flight information to be provided to a customer or the like from among the candidate flight information based on departure time, arrival time, cost, and so on.

In an embodiment, the flight path providing apparatus 1000 may determine the recommended flight information by placing a weight on the departure time. In an embodiment, if the flight service request includes a request to prioritize the departure time, the flight information including the earliest departure time among the candidate flight information may be determined as the recommended flight information.

In an embodiment, the flight path providing apparatus 1000 may determine the recommended flight information by placing a weight on the arrival time. In an embodiment, if the flight service request includes a request to prioritize the arrival time, the flight information including the earliest arrival time among the candidate flight information may be determined as the recommended flight information.

In an embodiment, the flight path providing apparatus 1000 may determine the recommended flight information by placing a weight on the cost. In an embodiment, if the flight service request includes a request to prioritize the cost, the flight information including the lowest cost among the candidate flight information may be determined as the recommended flight information.

In step S2600, the flight path providing apparatus 1000 may transmit at least one recommended flight information to the user terminal. Thereafter, when a request to select a recommended flight path is received from the user terminal, the flight path providing apparatus 1000 may confirm the corresponding recommended flight path as the flight path to be provided to the customer.

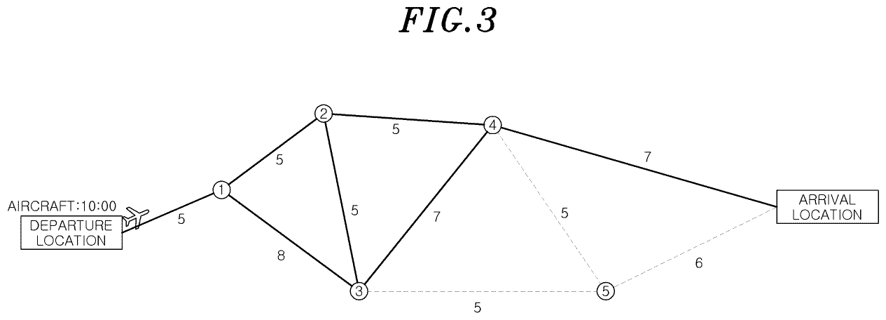

FIGS. 3 to 7 are diagrams for explaining a recommended path providing method according to an embodiment of the present invention.

Referring to FIG. 3, five waypoints located between a departure location and an arrival location and the flight duration between the waypoints are shown. The flight path providing apparatus 1000 may generate a minimum flight path based on waypoints 1 to 4, excluding waypoint 5 which is a prohibited waypoint, among the five waypoints.

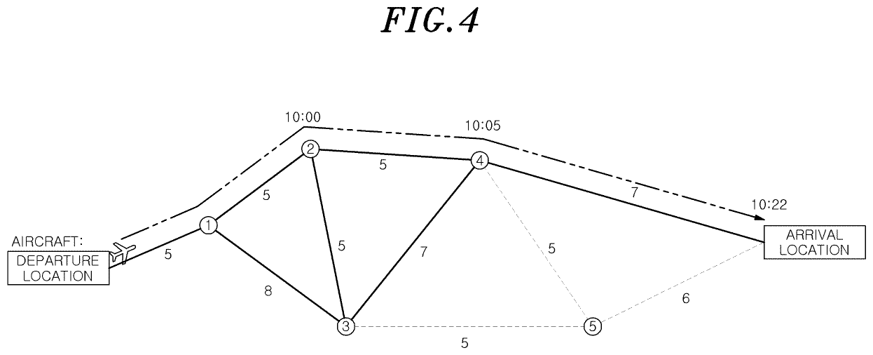

Referring to FIG. 4, the flight path providing apparatus 1000 may apply a minimum path algorithm based on the flight duration between waypoints 1 to 4, thereby determining a path with the minimum flight time from the departure location to the arrival location, that is, a minimum flight path composed of waypoints 1, 2, and 4.

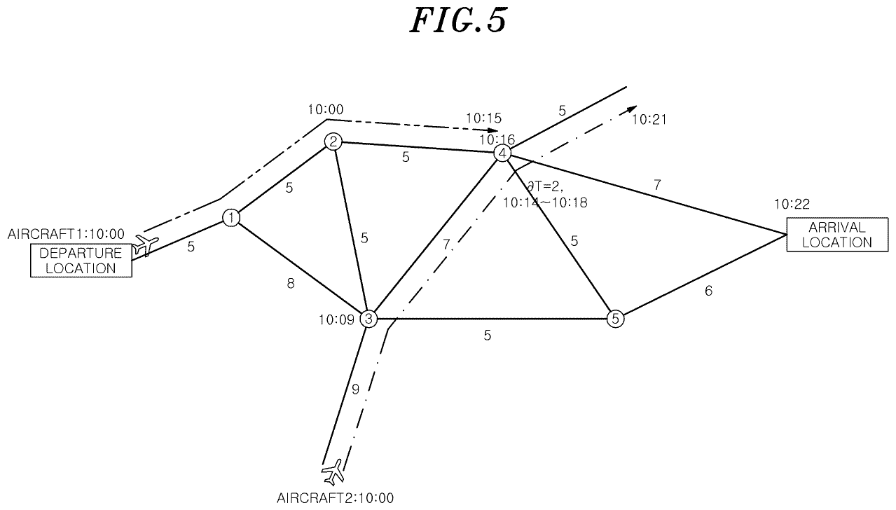

Referring to FIG. 5, the flight path providing apparatus 1000 may determine whether there is a collision possibility with aircraft 2 when aircraft 1 flies along a candidate flight path. Aircraft 1 departs from the departure location at 10:00 AM and passes through waypoints 1, 2, and 4 to arrive at the arrival location. Aircraft 2 departs at 10:00 AM and passes through waypoints 3 and 4. Since aircraft 1 is scheduled to arrive at waypoint 4 at 10:15 AM and aircraft 2 is scheduled to arrive at waypoint 4 at 10:16 AM, there may be a possibility of collision at waypoint 4. At this time, the flight path providing apparatus 1000 may calculate a time range for avoiding a collision at the waypoint 4, that is, an avoidance time range (e.g., −2 minutes to +2 minutes).

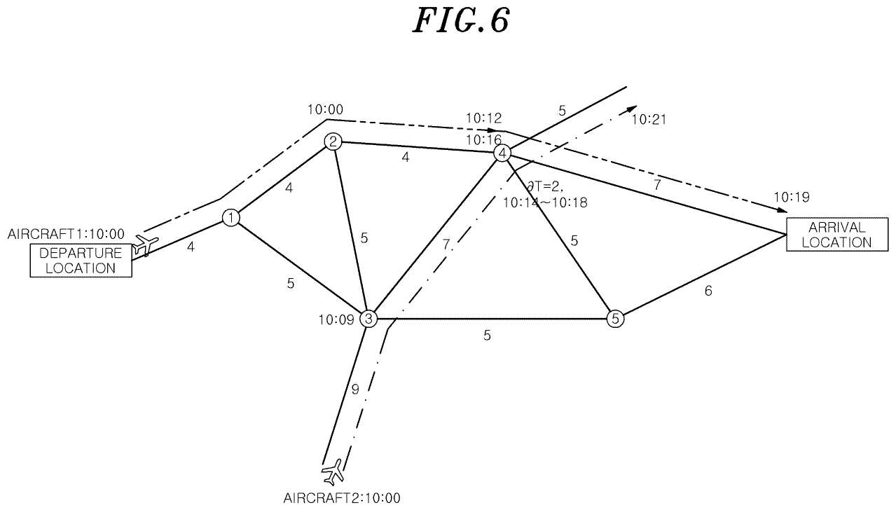

Referring to FIG. 6, the flight path providing apparatus 1000 may change the flight duration between waypoints so that aircraft 1 does not pass through waypoint 4 within the avoidance time range. For example, if the preset flight duration from the departure location to waypoint 1 is 5 minutes, the flight path providing apparatus 1000 may change the flight duration to 4 minutes. Furthermore, although not shown in FIG. 6, the flight path providing apparatus 1000 may change the departure time so that the time aircraft 1 passes through waypoint 4 is not within the avoidance time range. In this case, the flight path providing apparatus 1000 may generate candidate flight information including the changed flight duration, the changed arrival time, a flight path composed of waypoints 1, 2, and 4, and the like.

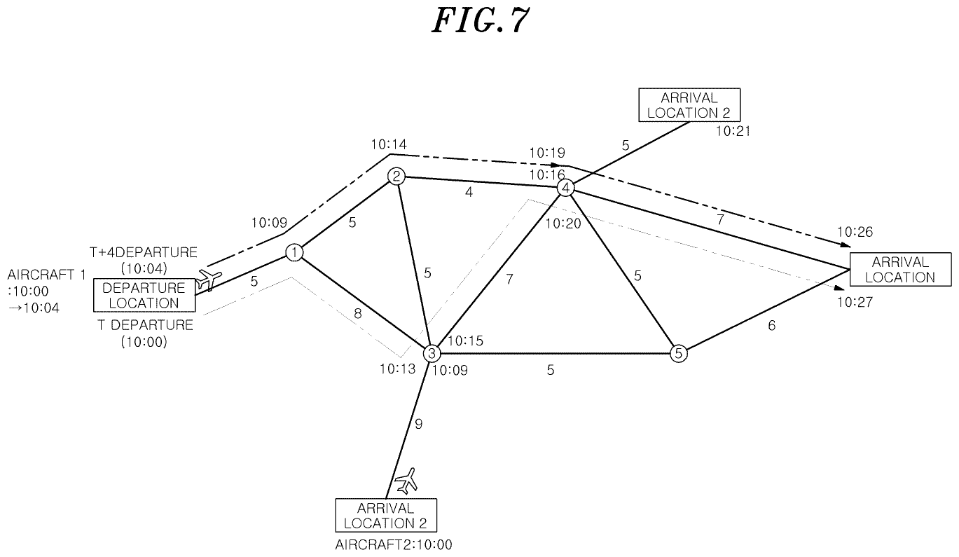

Referring to FIG. 7, the flight path providing apparatus 1000 may change the departure time so that aircraft 1 does not pass through waypoint 4 within the avoidance time range. At this time, the flight path providing apparatus 1000 may generate candidate flight information including the changed departure time, arrival time, a flight path composed of waypoints 1, 2, and 4, and the like.

Furthermore, the flight path providing apparatus 1000 may change the path from departure location 1 to waypoint 4 from waypoints 1, 2, and 4 to waypoints 1, 3, and 4 so that aircraft 1 does not pass through waypoint 4 within the avoidance time range. At this time, the flight path providing apparatus 1000 may generate candidate flight information including the changed flight path (waypoints 1, 3, and 4), the changed arrival time, and the like.

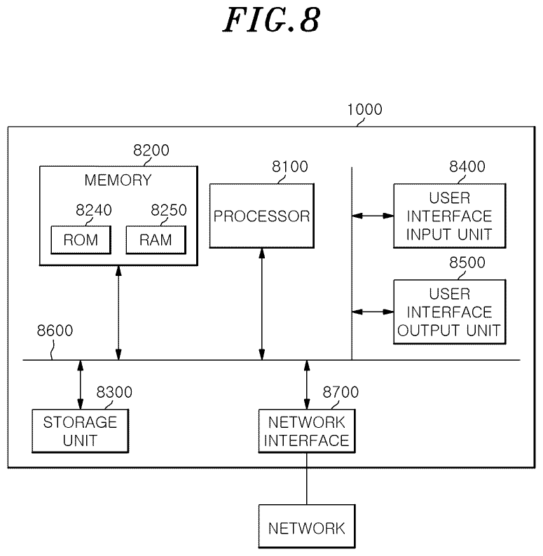

FIG. 8 is a block diagram of a flight path providing apparatus according to another embodiment of the present invention.

As shown in FIG. 8, the flight path providing apparatus 1000 may include at least one or more of a processor 8100, a memory 8200, a storage unit 8300, a user interface input unit 8400, and a user interface output unit 8500, which may communicate with each other via a bus 8600. Furthermore, the flight path providing apparatus 1000 may also include a network interface 8700 for connecting to a network. The processor 8100 may be a CPU or a semiconductor device that executes processing instructions stored in the memory 8200 and/or the storage 8300. The memory 8200 and the storage unit 8300 may include various types of volatile/non-volatile storage media. For example, the memory may include ROM 8240 and RAM 8250.

The apparatuses described above may be implemented as hardware components, software components, and/or a combination of hardware components and software components. For example, the apparatuses and components described in the embodiments may be implemented using one or more general-purpose computers or special-purpose computers, such as, for example, a processor, a controller, an arithmetic logic unit (ALU), a digital signal processor, a microcomputer, a field programmable array (FPA), a programmable logic unit (PLU), a microprocessor, or any other device capable of executing and responding to instructions. The processing device may execute an operating system (OS) and one or more software applications running on the operating system.

Furthermore, the processing device may respond to the execution of software to access, store, manipulate, process, and generate data. For convenience of understanding, it may be described that one processing device is used, but a person of ordinary skill in the art will understand that the processing device may include a plurality of processing elements and/or a plurality of types of processing elements. For example, the processing device may include a plurality of processors or one processor and one controller. Furthermore, other processing configurations, such as a parallel processor, are also possible.

Software may include a computer program, code, instructions, or a combination of one or more thereof, and may configure the processing device to operate as desired or command the processing device independently or collectively. Software and/or data may be permanently or temporarily embodied in any type of machine, component, physical device, virtual equipment, computer storage medium or device, or a transmitted signal wave, in order to be interpreted by the processing device or to provide instructions or data to the processing device. Software may be distributed over networked computer systems and may be stored or executed in a distributed manner. Software and data may be stored on one or more computer-readable recording media.

The above description is merely illustrative of the technical idea of an embodiment, and various modifications and variations will be possible for those of ordinary skill in the relevant art without departing from the essential qualities of an embodiment. Accordingly, the embodiments disclosed in this specification are not intended to limit the technical idea of an embodiment but to describe it, and the scope of the technical idea of an embodiment is not limited by these embodiments. The scope of protection of an embodiment should be interpreted by the claims below, and all technical ideas within the equivalent scope should be interpreted as being included in the scope of rights of an embodiment.

What is claimed is:

1. A method for providing flight path using a flight path providing apparatus, the method comprising:
calculating at least one candidate departure time and at least one candidate arrival time based on a flight service request including a desired departure time, a departure location, and an arrival location;
generating at least one candidate flight path based on the at least one candidate departure time and the at least one candidate arrival time;
generating at least one candidate flight information including a flight path, a departure time, and an arrival time corresponding to the at least one candidate flight path that satisfies at least one among the at least one candidate departure time and the at least one candidate arrival time; and
determining recommended flight information from among the at least one candidate flight information based on at least one of the flight path, the departure time, and the arrival time included in the at least one candidate flight information.

2. The method of claim 1, wherein the calculating at least one candidate departure time and at least one candidate arrival time includes:
determining, as the at least one candidate departure time, at least one time that is within a preset time based on the desired departure time among times available for using the departure location;
calculating a minimum flight time between the departure location and the arrival location; and
calculating at least one candidate arrival time based on the at least one candidate departure time and the minimum flight time.

3. The method of claim 2, wherein the calculating the minimum flight time between the departure location and the arrival location includes:
calculating a flight time corresponding to a minimum flight path between the departure location and the arrival location as the minimum flight time.

4. The method of claim 3, wherein the generating the minimum flight path between the departure location and the arrival location includes:
generating the minimum flight path based on a preset flight duration between a plurality of waypoints located between the departure location and the arrival location.

5. The method of claim 1, wherein the generating at least one candidate flight information includes:
determining whether there is a collision possibility with another aircraft while flying along the at least one candidate flight path; and
when it is determined the collision possibility exists, calculating a departure time and an arrival time corresponding to the at least one candidate flight path by changing at least one of the candidate departure time and a preset flight duration between waypoints constituting the at least one candidate flight path.

6. The method of claim 2, wherein the calculating at least one candidate arrival time based on the at least one candidate departure time and the minimum flight time includes:
determining, as the at least one candidate arrival time, at least one time after the minimum flight time has elapsed from the at least one candidate departure time among times available for using the arrival location.

7. The method of claim 1, wherein the at least one candidate flight information further includes a cost corresponding to the at least one candidate flight path, and
wherein, in the determining the recommended flight information from among the at least one candidate flight information, the recommended flight information is determined by further including the cost.

8. A non-transitory computer-readable storage medium storing a computer program, wherein the computer program includes instructions for causing a processor to perform the method comprising:
calculating at least one candidate departure time and at least one candidate arrival time based on a flight service request including a desired departure time, a departure location, and an arrival location;
generating at least one candidate flight path based on the at least one candidate departure time and the at least one candidate arrival time;
generating at least one candidate flight information including a flight path, a departure time, and an arrival time corresponding to the at least one candidate flight path that satisfies at least one among the at least one candidate departure time and the at least one candidate arrival time; and
determining recommended flight information from among the at least one candidate flight information based on at least one of the flight path, the departure time, and the arrival time included in the at least one candidate flight information.

9. The non-transitory computer-readable storage medium of claim 8, wherein the calculating at least one candidate departure time and at least one candidate arrival time includes:
determining, as the at least one candidate departure time, at least one time that is within a preset time based on the desired departure time among times available for using the departure location;
calculating a minimum flight time between the departure location and the arrival location; and
calculating at least one candidate arrival time based on the at least one candidate departure time and the minimum flight time.

10. The non-transitory computer-readable storage medium of claim 9, wherein the calculating the minimum flight time between the departure location and the arrival location includes:
calculating a flight time corresponding to a minimum flight path between the departure location and the arrival location as the minimum flight time.

11. The non-transitory computer-readable storage medium of claim 10, wherein the generating the minimum flight path between the departure location and the arrival location includes:
generating the minimum flight path based on a preset flight duration between a plurality of waypoints located between the departure location and the arrival location.

12. The non-transitory computer-readable storage medium of claim 8, wherein the generating at least one candidate flight information includes:
determining whether there is a collision possibility with another aircraft while flying along the at least one candidate flight path; and
when it is determined the collision possibility exists, calculating a departure time and an arrival time corresponding to the at least one candidate flight path by changing at least one of the candidate departure time and a preset flight duration between waypoints constituting the at least one candidate flight path.

13. The non-transitory computer-readable storage medium of claim 9, wherein the calculating at least one candidate arrival time based on the at least one candidate departure time and the minimum flight time includes:
determining, as the at least one candidate arrival time, at least one time after the minimum flight time has elapsed from the at least one candidate departure time among times available for using the arrival location.

14. The non-transitory computer-readable storage medium of claim 8, wherein the at least one candidate flight information further includes a cost corresponding to the at least one candidate flight path, and
wherein, in the determining the recommended flight information from among the at least one candidate flight information, the recommended flight information is determined by further including the cost.

15. A flight path providing apparatus, comprising:
a memory including instructions; and
a processor executing the instructions wherein instructions, when executed by the processor, causes the processor to:
calculate at least one candidate departure time and at least one candidate arrival time based on a flight service request including a desired departure time, a departure location, and an arrival location,
generate at least one candidate flight path based on the at least one candidate departure time and the at least one candidate arrival time,
generate at least one candidate flight information including a flight path, a departure time, and an arrival time corresponding to the at least one candidate flight path that satisfies at least one among the at least one candidate departure time and the at least one candidate arrival time, and
determine recommended flight information from among the at least one candidate flight information based on at least one of the flight path, the departure time, and the arrival time included in the at least one candidate flight information.

16. The flight path providing apparatus of claim 15, wherein the processor is configured to:
determine, as the at least one candidate departure time, at least one time that is within a preset time based on the desired departure time among times available for using the departure location;
calculate a minimum flight time between the departure location and the arrival location; and
calculate at least one candidate arrival time based on the at least one candidate departure time and the minimum flight time.

17. The flight path providing apparatus of claim 16, wherein the processor is configured to:
calculate a flight time corresponding to a minimum flight path between the departure location and the arrival location as the minimum flight time.

18. The flight path providing apparatus of claim 17, wherein the processor is configured to:
generate the minimum flight path based on a preset flight duration between a plurality of waypoints located between the departure location and the arrival location.

19. The flight path providing apparatus of claim 15, wherein the processor is configured to:
determine whether there is a collision possibility with another aircraft while flying along the at least one candidate flight path; and
when it is determined the collision possibility exists, calculate a departure time and an arrival time corresponding to the at least one candidate flight path by changing at least one of the candidate departure time and a preset flight duration between waypoints constituting the at least one candidate flight path.

20. The flight path providing apparatus of claim 16, wherein the processor is configured to:
determinine, as the at least one candidate arrival time, at least one time after the minimum flight time has elapsed from the at least one candidate departure time among times available for using the arrival location.
